(19) United States
(12) Patent Application Publication
(10) Pub. No.: US 2012/0314425 A1
(43) Pub. Date: Dec. 13, 2012

(54) TURN LAMP UNIT

(75) Inventors: Akira FUKAI, Fujieda-shi (JP); Hiroya MIWA, Fujieda-shi (JP); Ryo INUZUKA, Fujieda-shi (JP)

(73) Assignee: MURAKAMI CORPORATION, Shizuoka (JP)

(21) Appl. No.: 13/482,245

(22) Filed: May 29, 2012

(30) Foreign Application Priority Data
Jun. 7, 2011 (JP) 2011-127504
Apr. 25, 2012 (JP) 2012-100327

(51) Int. Cl. F21V 5/04

(52) U.S. Cl. 362/335

(57) ABSTRACT

A turn lamp unit has a substrate holding unit for use when assembling a rigid substrate equipped with a lamp to a base member. This substrate holding unit comprises a board-like substrate mount rising from a bottom face on the inner face side of the base member; a pair of elastic pressers, which rise from a flat part of the substrate mount and are arranged so as to oppose each other in a width direction of the base member (i.e., a vertical direction in the state where the turn lamp unit is mounted to a door mirror), for pressing the front face of the rigid substrate by elasticity and thereby holding the rigid substrate at the substrate mount; and a projection, disposed on the substrate mount between the pair of elastic pressers, for abutting against the rear face of the rigid substrate.

### CROSS-REFERENCE TO RELATED APPLICATIONS

This application claims priority to Japanese Patent Applications No. 2011-127504 filed on Jun. 7, 2011 and No. 2012-100327 filed on Apr. 25, 2012, the entire contents of which are incorporated by reference herein.

### BACKGROUND OF THE INVENTION

1. Field of the Invention

The present invention relates to a turn lamp unit attachable to an outer mirror mounted to a vehicle such as an automobile.

2. Related Background Art

As a technique in such a field, Japanese Patent Application Laid-Open No. 2009-46037 has conventionally been known. A turn lamp unit mounted to an outer mirror disclosed in this publication comprises a base (base member) having attachment legs to be fastened by screws to a housing of a side mirror and a lens cover, attached to the base, for diffusing light. The base of the turn lamp unit is equipped with an LED, which is secured to a rigid substrate having leads connected thereto, while the rigid substrate is fastened to the base by two screws. The leads are let out through an opening formed in the base.

### SUMMARY OF THE INVENTION

### Technical Problem

In the conventional turn lamp unit, however, the rigid substrate equipped with the LED is secured to the base by screws, which makes it necessary to fasten the screws while holding the rigid substrate during the operation, thereby lowering the workability. When the screwing torque is high, buckling is likely to occur in the rigid substrate. When the screwing torque is low, the rigid substrate tends to jounce, thereby peeling the solder of the LED and breaking lines. For avoiding such inconveniences, it is necessary to narrow the width for managing the screwing torque and so forth, which is problematic.

It is an object of the present invention to provide a turn lamp unit with fine workability in assembling the lamp.

### Solution to Problem

The turn lamp unit in accordance with the present invention comprises a base member; a rigid substrate adapted to mount a lamp on a front face side thereof; a substrate holding unit, disposed on the base member, for holding the rigid substrate; and a lens cover secured to the base member; wherein the substrate holding unit has a substrate mount formed on the lens cover side of the base member; a pair of elastic pressers, arranged so as to project from the substrate mount and oppose each other, for pressing the front face of the rigid substrate by elasticity and holding the rigid substrate at the substrate mount; and a projection disposed on the substrate mount between the pair of elastic pressers so as to abut against a rear face of the rigid substrate.

In this turn lamp unit, a pair of elastic pressers projecting from the substrate mount are used when securing a rigid substrate to a substrate mount formed on the inner face side of a base member. The pair of elastic pressers, which are arranged so as to project from the substrate mount and oppose each other, press the front face of the rigid substrate by elasticity. A projection is formed on the substrate mount between the pair of elastic pressers, while the elastically deformable elastic pressers press the rear face of the rigid substrate against the projection, whereby the rigid substrate can reliably be secured to the substrate mount without greatly bending the rigid substrate by unreasonable forces. When securing the rigid substrate equipped with a lamp to the substrate mount, no screwing operation is necessary, whereby the lamp assembling operation becomes favorable.

The projection may extend linearly on one surface of the substrate mount, the pair of elastic pressers being located on both sides of the projection on the one surface of the substrate mount, respectively.

Each elastic presser may be formed into an L shape and have a base arranged at such a position as to penetrate through the rigid substrate while projecting from the substrate mount substantially orthogonally to the rigid substrate and an elastic claw, extending substantially orthogonally to the base on the leading end side of the base, for pressing the rigid substrate, the rigid substrate having a pair of slits for passing the pair of bases therethrough, each slit opening on one end part side of the rigid substrate.

Employing such a structure can mount the rigid substrate to the substrate mount so as to insert the bases of the elastic pressers to the slits of the rigid substrate. In this operation, the slits of the rigid substrate function as guides, so that the rigid substrate can reliably be placed at a predetermined position. Also, after the bases of the elastic pressers enter the slits of the rigid substrate, the rigid substrate can be prevented from shifting and jouncing. Since the elastic pressers are not arranged so as to protrude from peripheries of the rigid substrate, the substrate holding unit can save its space, whereby the base member can be made smaller.

The pair of elastic claws may extend away from the projection.

Each elastic presser may be formed into an L shape and have a base arranged on the outside of the rigid substrate so as to project from the substrate mount substantially orthogonally to the rigid substrate and an elastic claw, extending to the rigid substrate while being substantially orthogonal to the base on the leading end side of the base, for pressing the rigid substrate.

Employing such a structure can mount the rigid substrate to the substrate mount so that the pair of bases of the elastic pressers hold the rigid substrate therebetween.

The rigid substrate may be provided with a pair of depressions or a pair of holes, while the elastic claws may have respective free ends formed with protrusions adapted to fit to the pair of depressions or pair of holes.

When such a structure is employed, the protrusions provided at the free ends of the elastic claws fit to the depressions or holes of the rigid substrate, so as to prevent the rigid substrate from shifting its position with respect to the substrate mount. Also, a click can be felt when the protrusion enters the depression or hole in the lamp assembling operation, whereby reliability is secured in the operation.

### BRIEF DESCRIPTION OF THE DRAWINGS

FIG. 1 is a perspective view illustrating a first embodiment of the turn lamp unit in accordance with the present invention;

FIG. 2 is an enlarged plan view of a main part of a base member;

FIG. 3 is an enlarged perspective view of an elastic presser;

FIG. 4 is a front view illustrating a state where a rigid substrate is assembled to the base member;

FIG. 5 is a sectional view illustrating a state where the rigid substrate is assembled to a substrate holding unit;

FIG. 6 is a perspective view illustrating a second embodiment of the turn lamp unit in accordance with the present invention;

FIG. 7 is a sectional view illustrating a state where the rigid substrate is assembled to the substrate holding unit;

FIG. 8 is a perspective view illustrating a third embodiment of the turn lamp unit in accordance with the present invention;

FIG. 9 is a perspective view illustrating a fourth embodiment of the turn lamp unit in accordance with the present invention;

FIG. 10 is a perspective view illustrating a fifth embodiment of the turn lamp unit in accordance with the present invention;

FIG. 11 is an enlarged plan view illustrating a main part of a modified example of the elastic presser; and

FIG. 12 is an enlarged plan view illustrating a main part of another modified example of the elastic presser.

### DESCRIPTION OF THE PREFERRED EMBODIMENTS

In the following, preferred embodiments of the turn lamp unit in accordance with the present invention will be explained in detail with reference to the drawings.

### First Embodiment

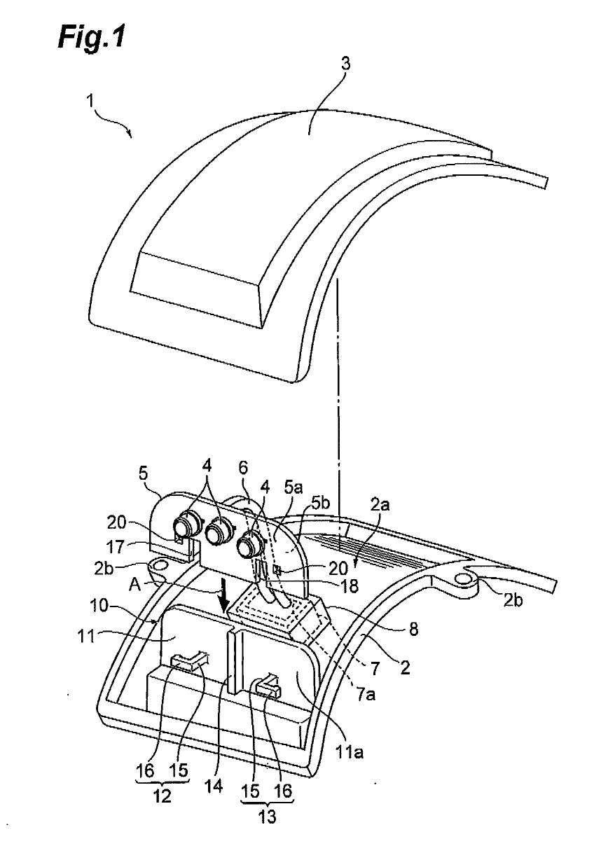

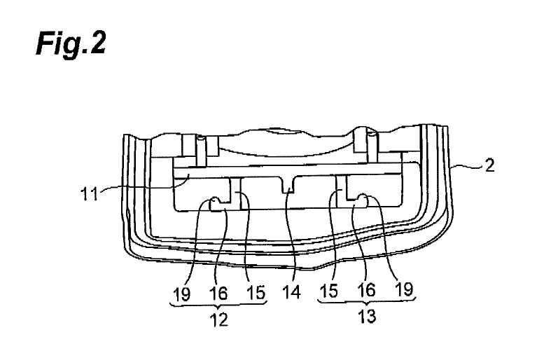

As illustrated in FIGS. 1 and 2, a turn lamp unit 1 is one which is fastened to a housing of an outer mirror, e.g., a door mirror, by screws and functions as a direction indicator. This turn lamp unit 1 comprises a base member 2 which is formed like a flat sheet by a resin and has attachment legs 2b to be fastened to the housing of the door mirror by screws, a lens cover 3 made of a resin and adapted to fit to the base member 2 with a gasket interposed therebetween, lamps (e.g., LED) 4, and a rigid substrate 5 having the lamps 4 arranged on a front face 5a side thereof.

The base member 2 is provided with an opening 7a through which leads 6 connected to a rear face 5b of the rigid substrate 5 are let out of the turn lamp unit 1, while the opening 7a is formed with a tube 7 projecting from an inner face of the base member 2. A waterproof cap 8 is fitted to the tube 7 so as to close the opening 7a, while the leads 6 penetrate through the waterproof cap 8.

The base member 2 has a long and thin curved form along a lens cover 3 shaped so as to match the outer form of the door mirror. In order for an end part of the turn lamp unit 1 to emit light, an end part on the inner face side of the base member 2 is formed with a substrate holding unit 10 for holding the rigid substrate 5.

The substrate holding unit 10 comprises a board-like substrate mount 11 rising from a bottom face 2a on the inner face side of the base member 2; a pair of elastic pressers 12, 13, which rise from a flat part 11a of the substrate mount 11 and are arranged so as to oppose each other in a width direction of the base member 2 (i.e., a vertical direction in the state where the turn lamp unit 1 is mounted to the door mirror), for pressing the front face 5a of the rigid substrate 5 by elasticity and thereby holding the rigid substrate at the substrate mount 11; and a projection 14, disposed on the substrate mount 11 between the pair of elastic pressers 12, 13, for abutting against the rear face 5b of the rigid substrate 5.

The first and second elastic pressers 12, 13, each of which is formed like letter L as a finger, are bilaterally symmetric to each other about the projection 14 linearly extending on the flat part 11a of the substrate mount 11. The first elastic presser 12 comprises a base 15 arranged at such a position as to penetrate through the rigid substrate 5 while projecting from the substrate mount 11 substantially orthogonally to the rigid substrate 5 and an elastic claw 16, extending substantially perpendicularly to the base 15 on the leading end side of the base 15, for pressing the front face 5a side of the rigid substrate 5.

As with the first elastic presser 12, the second elastic presser 13 has a base 15 and an elastic claw 16. The elastic claws 16 of the first and second elastic pressers 12, 13 are directed outward (away from the projection 14).

On the other hand, the rigid substrate 5 is provided with a pair of slits 17, 18 which open to an end part side of the rigid substrate 5 and allow the bases 15 to be inserted therein from the opening on the end part side. Each of the slits 17, 18 extends in the insertion direction (arrowed direction A) of the rigid substrate 5. The projection 14 also extends in the insertion direction. Each of the slits 17, 18 has a width substantially equal to or slightly greater than the width of each of the bases 15 of the first and second elastic pressers 12, 13.

Employing such a structure can mount the rigid substrate 5 to the substrate mount 11 so as to insert the bases 15 of the elastic pressers 12, 13 to the slits 17, 18 of the rigid substrate 5. In this operation, the slits 17, 18 of the rigid substrate 5 function as guides, so that the rigid substrate 5 can reliably be placed at a predetermined position. After the bases 15 of the elastic pressers 12, 13 enter the slits 17, 18 of the rigid substrate 5, the rigid substrate 5 can be prevented from shifting and jouncing. Since the elastic pressers 12, 13 are not arranged so as to protrude from peripheries of the rigid substrate 5, the substrate holding unit 10 can save its space, whereby the base member 2 can be made smaller.

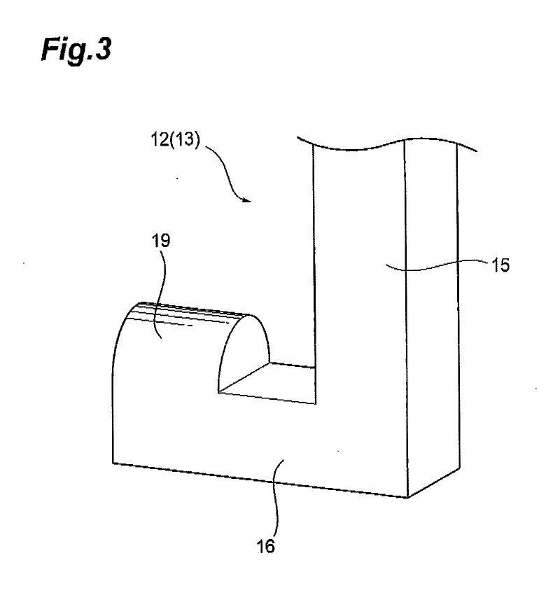

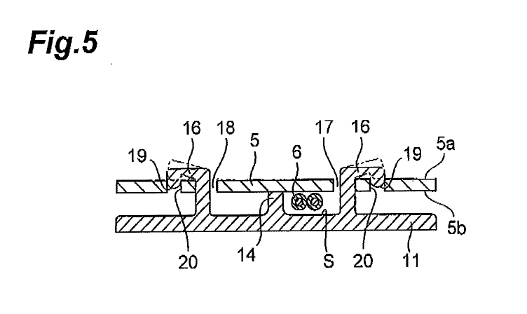

As illustrated in FIG. 3, each elastic claw 16 has a free end formed with a protrusion 19 shaped like a semicircular column adapted to fit to a rectangular hole 20 formed in the rigid substrate 5 (see FIG. 1). Fitting the protrusions 19 to their corresponding holes 20 of the rigid substrate 5 prevents the rigid substrate 5 from shifting its position with respect to the substrate mount 11. Also, a click can be felt when the protrusion 19 enters the hole 20 in the lamp assembling operation as illustrated in FIG. 5, whereby reliability is secured in the operation.

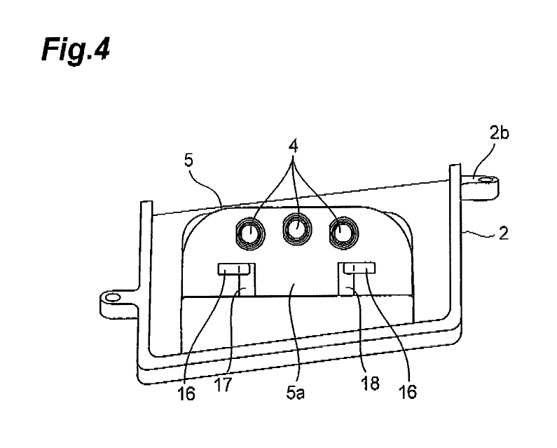

In this turn lamp unit 1, as illustrated in FIG. 4, the pair of elastic pressers 12, 13 projecting from the substrate mount 11 are used when securing the rigid substrate 5 to the substrate mount 11 formed on the inner face side of the base member 2. The pair of elastic pressers 12, 13, which are arranged so as to oppose each other, press the front face 5a of the rigid substrate 5 by elasticity. The elastically deformable elastic pressers 12, 13 also press the rear face 5b of the rigid substrate 5 against the projection 14 formed on the substrate mount 11 between the pair of elastic pressers 12, 13.

The substrate mount 11 is provided with the projection 14. Therefore, if the elastic pressers 12, 13 have no elasticity, it will be necessary to secure the rigid substrate 5 to the substrate mount 11 by forcibly flexing the rigid substrate 5, which may lower the workability and generate a load to the rigid substrate 5. When the elastic pressers 12, 13 are made elastically deformable, by contrast, the rigid substrate 5 can reliably be secured to the substrate mount 11 without being forcibly flexed. When securing the rigid substrate 5 equipped with the lamps 4 to the substrate mount 11, no screwing operation is necessary, whereby the workability in assembling the lamps 4 becomes favorable.

When the leads 6 are connected to the rear face 5b of the rigid substrate 5 by soldering, the deformation-restoring force of the leads 6 makes it hard for the rigid substrate 5 to be secured to the substrate mount 11 by screws. However, employing the elastic pressers 12, 13 can secure the rigid substrate 5 to the substrate mount 11 by one touch, whereby the workability becomes very fine.

Further, as illustrated in FIG. 5, the projection 14 can produce a lead accommodation space S between the rigid substrate 5 and the substrate mount 11, whereby the rigid substrate 5 can be secured to the substrate mount 11 by one touch without being obstructed by the leads 6 even when the leads 6 are connected to the rear face 5b of the rigid substrate 5 by soldering.

### Second Embodiment

A turn lamp unit 1A in accordance with the second embodiment will now be explained, in which constituent parts identical or equivalent to those in the first embodiment will be referred to with the same signs while omitting their overlapping descriptions.

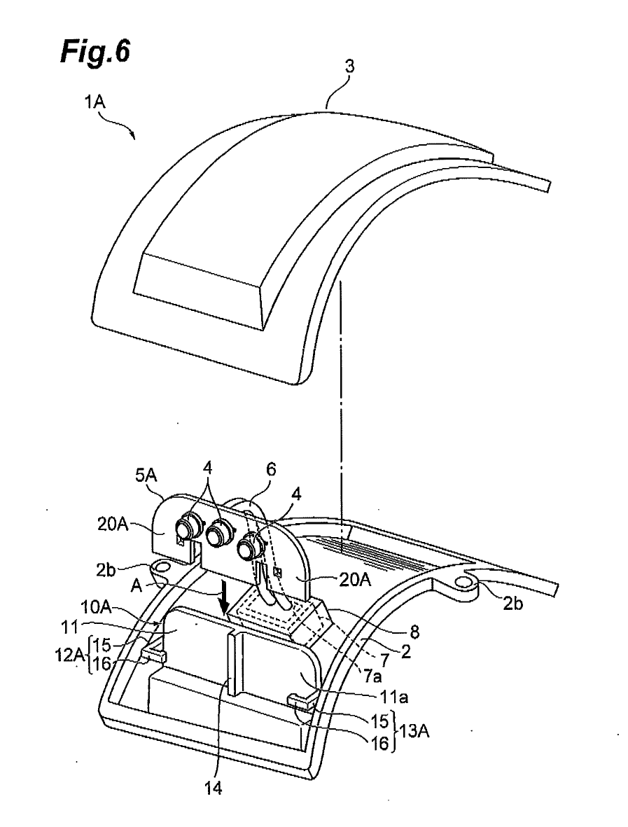

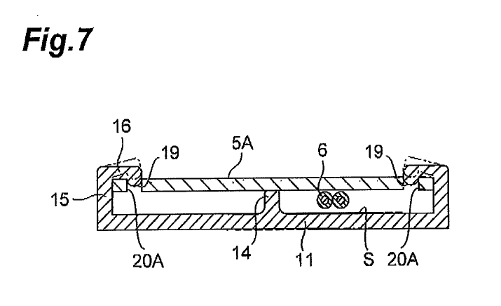

As illustrated in FIGS. 6 and 7, in the turn lamp unit 1A, a pair of elastic pressers 12A, 13A, each of which is formed like letter L as a finger, are bilaterally symmetric to each other about a projection 14 linearly extending on a flat part 11a of a substrate mount 11. The first elastic presser 12A comprises a base 15 which is arranged on the outside of a rigid substrate 5A and projects from the substrate mount 11 substantially orthogonally to the rigid substrate 5A and an elastic claw 16, extending to the rigid substrate 5A while being substantially orthogonal to the base 15 on the leading end side of the base 15, for pressing the rigid substrate 5A.

As with the first elastic presser 12A, the second elastic presser 13A has a base 15 and an elastic claw 16. The elastic claws 16 of the first and second elastic pressers 12A, 13A are directed inward (toward the projection 14). Employing thus constructed first and second elastic pressers 12A, 13A can secure the rigid substrate 5A to the substrate mount 11 so that the pair of bases 15 of the elastic pressers 12A, 13A hold the rigid substrate 5A therebetween.

As illustrated in FIGS. 6 and 7, each elastic claw 16 has a free end formed with a protrusion 19 shaped like a semicircular column adapted to fit to a rectangular hole 20A formed in the rigid substrate 5A. Fitting the protrusions 19 to their corresponding holes 20 of the rigid substrate 5 prevents the rigid substrate 5A from shifting its position with respect to the substrate mount 11. Also, a click can be felt when the protrusion 19 enters the hole 20A in the lamp assembling operation, whereby reliability is secured in the operation.

The present invention is not limited to the above-mentioned embodiments as a matter of course. In the following, constituent parts identical or equivalent to those in the first embodiment will be referred to with the same signs while omitting their overlapping descriptions.

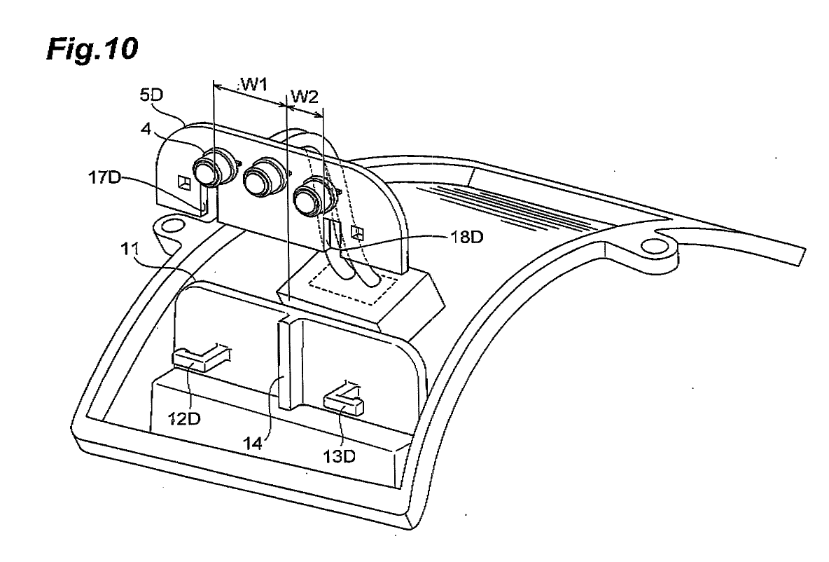

For example, in a modified embodiment illustrated in FIG. 10, first and second elastic pressers 12D, 13D are separated by different distances (W1, W2) from a projection 14 arranged at the center of a substrate mount 11. A rigid substrate 5D is formed with slits 17D, 18D to which first and second elastic pressers 12D, 13D fit, respectively. Such a structure can prevent the rigid substrate 5D from being erroneously assembled inside out when mounted to the substrate mount 11. This is effective in particular when the lamps (e.g., LED) 4 are small. When right- and left-side turn lamp units are bilaterally symmetric to each other, providing the left and right turn lamp units with different distances W1, W2 can prevent the left and right rigid substrates 5D from being erroneously assembled as being mistaken for each other.

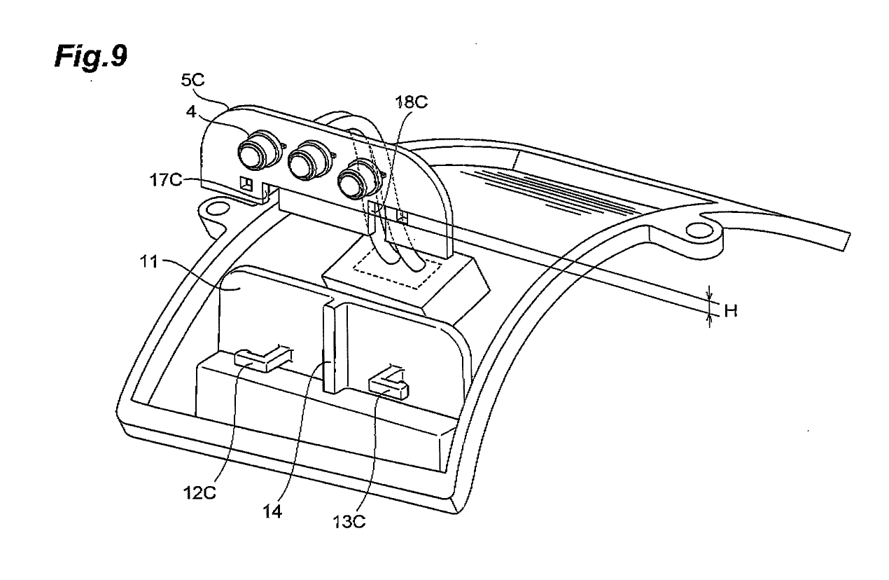

In another modified embodiment illustrated in FIG. 9, first and second elastic pressers 12C, 13C are located at respective positions different from each other by a height H in the extending direction of the projection 14. A rigid substrate 5C is formed with slits 17C, 18C to which first and second elastic pressers 12C, 13C fit, respectively. Such a structure can prevent the rigid substrate 5C from being erroneously assembled inside out when mounted to a substrate mount 11. This is effective in particular when the lamps (e.g., LED) 4 are small. When right- and left-side turn lamp units are bilaterally symmetric to each other, providing the left and right turn lamp units with different heights H can prevent the left and right rigid substrates 5C from being erroneously assembled as being mistaken for each other.

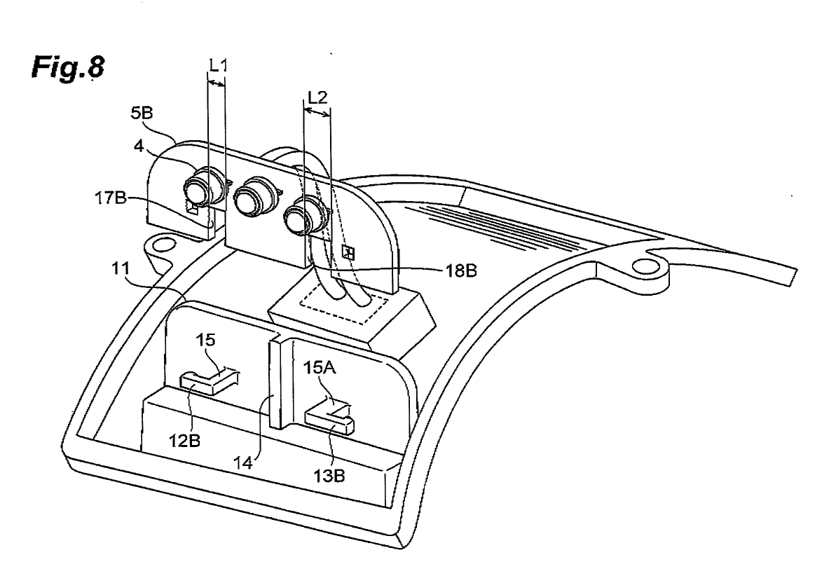

In still another modified embodiment illustrated in FIG. 8, first and second elastic pressers 12B, 13B are provided with respective bases 15, 15A having widths different from each other. A rigid substrate 5B is formed with slits 17B, 18B having different widths (L1, L2) to which first and second elastic pressers 12B, 13B fit, respectively. Such a structure can prevent the rigid substrate 5B from being erroneously assembled inside out when mounted to the substrate mount 11. This is effective in particular when the lamps (e.g., LED) 4 are small. When right- and left-side turn lamp units are bilaterally symmetric to each other, providing the left and right turn lamp units with different widths L1, L2 can prevent the left and right rigid substrates 5B from being erroneously assembled as being mistaken for each other.

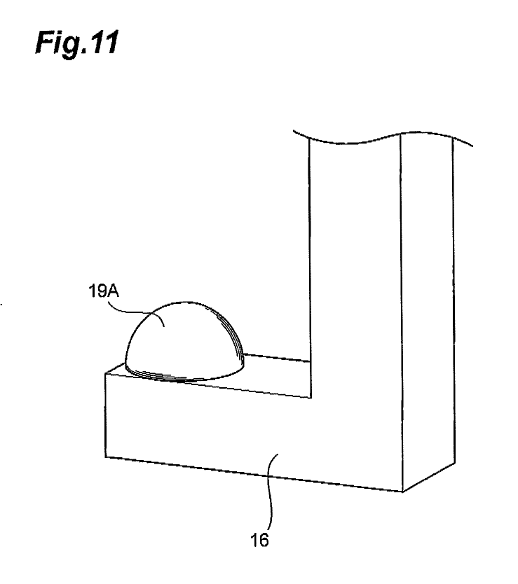

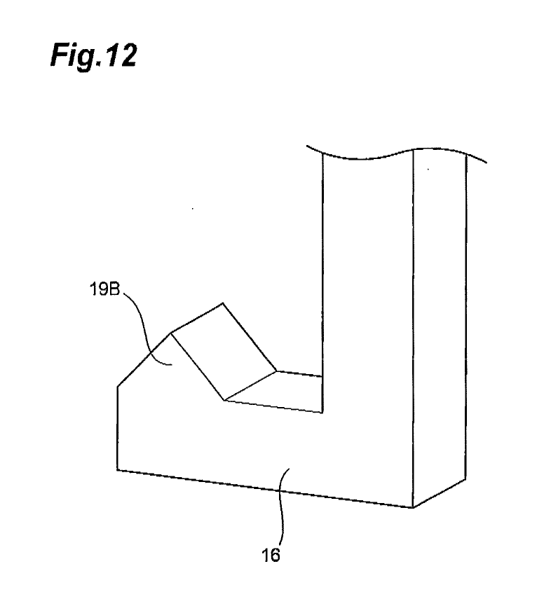

As illustrated in FIG. 11, a semispherical protrusion 19A may be formed at a free end of the elastic claw 16. As illustrated in FIG. 12, a protrusion 19B shaped like a triangular prism may be formed at a free end of the elastic claw 16.

In place of the holes 20, 20A, depressions, which are not depicted, may be formed in the rigid substrates 5, 5A to 5D for inserting the protrusions 19, 19A, 19B.

What is claimed is:

1. A turn lamp unit comprising:
a base member;
a rigid substrate adapted to mount a lamp on a front face side thereof;
a substrate holding unit, disposed on the base member, for holding the rigid substrate; and
a lens cover secured to the base member;
wherein the substrate holding unit has:
a substrate mount formed on the lens cover side of the base member;
a pair of elastic pressers, arranged so as to project from the substrate mount and oppose each other, for pressing the front face of the rigid substrate by elasticity and holding the rigid substrate at the substrate mount; and
a projection disposed on the substrate mount between the pair of elastic pressers so as to abut against a rear face of the rigid substrate.

2. A turn lamp unit according to claim 1, wherein the projection extends linearly on one surface of the substrate mount; and
wherein the pair of elastic pressers are located on both sides of the projection on the one surface of the substrate mount, respectively.

3. A turn lamp unit according to claim 1, wherein each of the elastic pressers is formed into an L shape and has:
a base arranged on the outside of the rigid substrate so as to project from the substrate mount substantially orthogonally to the rigid substrate; and
an elastic claw, extending to the rigid substrate while being substantially orthogonal to the base on the leading end side of the base, for pressing the rigid substrate;
wherein the rigid substrate has a pair of slits for passing the pair of bases therethrough; and
wherein each of the slits open on one end part side of the rigid substrate.

4. A turn lamp unit according to claim 3, wherein the pair of elastic claws extend away from the projection.

5. A turn lamp unit according to claim 1, wherein each of the elastic pressers is formed into an L shape and has:
a base arranged on the outside of the rigid substrate so as to project from the substrate mount substantially orthogonally to the rigid substrate; and
an elastic claw, extending to the rigid substrate while being substantially orthogonal to the base on the leading end side of the base, for pressing the rigid substrate.

6. A turn lamp unit according to one of claims 3, wherein the rigid substrate is provided with a pair of depressions or a pair of holes, while the elastic claws have respective free ends formed with protrusions adapted to fit to the pair of depressions or pair of holes.
